(19) United States
(12) Patent Application Publication
(10) Pub. No.: US 2015/0256905 A1
(43) Pub. Date: Sep. 10, 2015

(54) SERVER APPARATUS AND METHOD OF TRANSMITTING FINGER PRINT THEREOF, AND BROADCAST RECEIVING APPARATUS

(71) Applicant: SAMSUNG ELECTRONICS CO., LTD., Suwon-si (KR)

(72) Inventors: Jun-woo LEE, Suwon-si (KR); Kwang-hyun KOH, Seoul (KR); Tae-ung JUNG, Hwaseong-si (KR)

(73) Assignee: SAMSUNG ELECTRONICS CO., LTD., Suwon-si (KR)

(21) Appl. No.: 14/508,190

(22) Filed: Oct. 7, 2014

(30) Foreign Application Priority Data
Mar. 5, 2014 (KR) 10-2014-0025986

(51) Int. Cl. H04N 21/8352; H04N 21/44; H04H 60/59; H04H 60/58; H04N 21/439; H04N 21/84

(52) U.S. Cl. CPC H04N 21/8352; H04N 21/4394; H04N 21/84; H04H 60/59; H04H 60/58; H04N 21/44008

(57) ABSTRACT

A server apparatus includes a receiver configured to receive content, a data detector configured to detect a plurality of fingerprints from at least one of image data and voice data of the content, a controller configured to generate a fingerprint set selected as different fingerprints in consideration of similarity between the plural fingerprints, and a communicator configured to transmit the generated fingerprint set to a broadcast receiving apparatus.

### CROSS-REFERENCE TO RELATED APPLICATIONS

This application claims priority from Korean Patent Application No. 10-2014-0025986, filed on Mar. 5, 2014, in the Korean Intellectual Property Office, the disclosure of which is incorporated herein by reference in its entirety.

### BACKGROUND

1Field

Apparatuses and methods consistent with the embodiments relate to a server apparatus and a method of transmitting a fingerprint, and a broadcast receiving apparatus, and more particularly, to a server apparatus and a method of transmitting a fingerprint, and a broadcast receiving apparatus, for generating a fingerprint set in consideration of a similarity between plural fingerprint of content and transmitting the fingerprint set.

2. Description of the Related Art

As sources of broadcast content or multimedia content have changed to various sources, such as a cable, an Internet protocol television (IPTV), a video on demand (VOD), etc. from a public TV-oriented single source, it is important to recognize content viewed by users in order to provide services, such as targeting advertisement, program recommendation, etc.

A server apparatus for providing services, such as targeting advertisement, program recommendation, etc periodically detects fingerprints of content, stores the fingerprint information in a database, and transmits the fingerprint information to a broadcast receiving apparatus.

Upon receiving the fingerprint information, the broadcast receiving apparatus stores the fingerprint information in an internal memory. In addition, in response to predetermined content being reproduced, the broadcast receiving apparatus detects fingerprints from the reproduced content, compares the detected fingerprint information with the fingerprint information stored in the internal memory, and recognizes content viewed by the user according to whether the fingerprints and the stored fingerprint information match each other.

According to the aforementioned method, since the server apparatus continuously detects fingerprints of content, the server apparatus needs to store a higher number of fingerprints of content to be reproduced for a long period of time. Accordingly, the server apparatus requires large storage capacity, requires high transmission costs for transmission of fingerprint information to the broadcast receiving apparatus, and has a transmit rate that is reduced as the number of fingerprints is increased.

In addition, with regard to the broadcast receiving apparatus, if the number of fingerprints received from the server apparatus is increased, the aforementioned comparison operation needs to be frequently performed, thereby increasing the use of a central processing unit (CPU).

### SUMMARY

Exemplary embodiments overcome the above disadvantages and other disadvantages not described above. Also, the embodiments are not required to overcome the disadvantages described above, and an exemplary embodiment may not overcome any of the problems described above.

The embodiments provide a server apparatus and a method of transmitting a fingerprint, and a broadcast receiving apparatus, for generating a fingerprint set in consideration of similarity between plural fingerprints of content so as to transmit a fingerprint set occupying low capacity to a broadcast receiving apparatus with high speed.

According to an aspect of the embodiments, a server apparatus includes a receiver configured to receive content, a data detector configured to detect a plurality of fingerprints from at least one of image data and voice data of the content, a controller configured to generate a fingerprint set selected as different fingerprints in consideration of similarity between the plural fingerprints, and a communicator configured to transmit the generated fingerprint set to a broadcast receiving apparatus.

The server apparatus may further include a storage configured to store a set list including at least one fingerprint set. In this case, the controller may add the generated fingerprint set to the set list to update the set list.

The controller may transmit version information of the updated set list to the broadcast receiving apparatus through the communicator, and transmit the updated set list or the generated fingerprint set to the broadcast receiving apparatus in response to an update request being received from the broadcast receiving apparatus.

When a version of a set list pre-provided to the broadcast receiving apparatus is different from a version of the set list, the controller may transmit the updated set list or the generated fingerprint set to the broadcast receiving apparatus.

When predetermined event information about the content is prevent, the controller may match the event information to the fingerprint set and transmit the event information to the broadcast receiving apparatus.

When comparison activation information containing comparison initiation time and comparison completion time of the fingerprint set, the controller may transmit the comparison activation information to the broadcast receiving apparatus.

The data detector may sample a plurality of image frames among image frames included in the image data with a predetermined first period or sample a plurality of audio signal periods among audio signals included in the voice data with a predetermined second period to detect the plural fingerprints.

In response to the plural image frames being sampled, the controller may calculate similarity between neighboring image frames based on at least one of an indication position, a size, a shape, and a color of an object included in each of the plural image frames, and select an image frame one by one among image frames having similarity within a predetermined first range to generate the fingerprint set.

In response to the plural audio signal periods being sampled, the controller may calculate similarity between neighboring audio signal periods based on frequency characteristic and amplitude of an audio signal contained in each of the plural audio signal period, and select an audio signal period one by one among audio signal periods having similarity within a predetermined second range to generate the fingerprint set.

According to another aspect of the embodiments, a method of transmitting a fingerprint list of a server apparatus includes, in response to content being received, detecting a plurality of fingerprints from at least one of image data and voice data of the content, generating a fingerprint set selected as different fingerprints in consideration of similarity between the plural fingerprints, and transmitting the generated fingerprint set to a broadcast receiving apparatus.

The method may further include adding the generated fingerprint set to a set list including at least one fingerprint set to update the set list.

The transmitting may include transmitting version information of the updated set list to the broadcast receiving apparatus, and transmitting the updated set list or the generated fingerprint set to the broadcast receiving apparatus in response to an update request being received from the broadcast receiving apparatus.

The transmitting may include, when a version of a set list pre-provided to the broadcast receiving apparatus is different from a version of the set list, transmitting the updated set list or the generated fingerprint set to the broadcast receiving apparatus.

The transmitting may include, when predetermined event information about the content is prevent, matching the event information to the fingerprint set and transmitting the event information to the broadcast receiving apparatus.

The method may further include, when comparison activation information containing comparison initiation time and comparison completion time of the fingerprint set, transmitting the comparison activation information to the broadcast receiving apparatus.

The detecting may include sampling a plurality of image frames among image frames included in the image data with a predetermined first period or sampling a plurality of audio signal periods among audio signals included in the voice data with a predetermined second period to detect the plural fingerprints.

The generating may include, in response to the plural image frames being sampled, calculating similarity between neighboring image frames based on at least one of an indication position, a size, a shape, and a color of an object included in each of the plural image frames, and selecting an image frame one by one among image frames having similarity within a predetermined first range to generate the fingerprint set, and in response to the plural audio signal periods being sampled, calculating similarity between neighboring audio signal periods based on frequency characteristic and amplitude of an audio signal contained in each of the plural audio signal period, and selecting an audio signal period one by one among audio signal periods having similarity within a predetermined second range to generate the fingerprint set.

According to another aspect of the embodiments, a broadcast receiving apparatus for recognizing content viewed by a user includes a receiver configured to receive broadcast content, a display configured to display the broadcast content, a communicator configured to communicate with a server apparatus and to receive a fingerprint set including a plurality of fingerprints of content as a recognition target from the server apparatus, and a controller configured to detect a plurality of fingerprints from at least one of image data and voice data of the broadcast content, to compare the plural target fingerprints with the plural fingerprints, to generate content recognition information of a fingerprint matched with at least one of the plural target fingerprints, and to transmit the content recognition information to the server apparatus through the communicator, wherein the fingerprint set includes a plurality of fingerprints selected as different fingerprints in consideration of similarity between a plurality of fingerprints detected from at least one of image data and voice data of the content.

The content recognition information may include content identification information corresponding to a fingerprint matched to at least one of the plural target fingerprint and apparatus information of the broadcast receiving apparatus.

When predetermined event information of the content is matched to the fingerprint set, if at least one of the plural target fingerprints is matched to at least one fingerprint included in the fingerprint set, the controller may control the display to display the predetermined event information.

In response to comparison activation information including comparison initiation time and comparison completion time of the fingerprint set being from the server apparatus, the controller may activate an operation of detecting the plural target fingerprints and comparing the plural target fingerprints with the plural fingerprints according to the comparison initiation time, and deactivate an operation of detecting the plural target fingerprints and comparing the target fingerprints with the plural fingerprints according to the comparison completion time.

Additional and/or other aspects and advantages of the embodiments will be set forth in part in the description which follows and, in part, will be obvious from the description, or may be learned by practice of the embodiments.

According to an aspect of the embodiments a method is included that includes comparing a media fingerprint of broadcast media content with stored fingerprints of media content and displaying event information corresponding to a matching one of the stored fingerprints, where the stored fingerprints of media content are representative of different media content that may be broadcast.

### BRIEF DESCRIPTION OF THE DRAWING FIGURES

The above and/or other aspects of the embodiments will be more apparent by describing certain exemplary embodiments with reference to the accompanying drawings, in which:

FIG. 1 is a diagram of a content recognition system according to an embodiment;

FIG. 2 is a diagram illustrating a method of generating a fingerprint set according to an embodiment;

FIG. 3 is a diagram illustrating a structure of a server apparatus 200 according to an embodiment;

FIG. 4 is a diagram illustrating a structure of a broadcast receiving apparatus according to an embodiment;

FIG. 5 is a diagram illustrating a fingerprint matching method according to an embodiment;

FIGS. 6A-6C are diagrams illustrating a method of updating a fingerprint according to an embodiment;

FIG. 7 is a diagram illustrating a method of displaying event information according to an embodiment;

FIG. 8 is a flowchart for transmitting a fingerprint according to an embodiment; and

FIG. 9 is a flowchart for explanation of a method of recognizing content according to an embodiment.

### DETAILED DESCRIPTION OF THE EXEMPLARY EMBODIMENTS

Certain exemplary embodiments will now be described in greater detail with reference to the accompanying drawings.

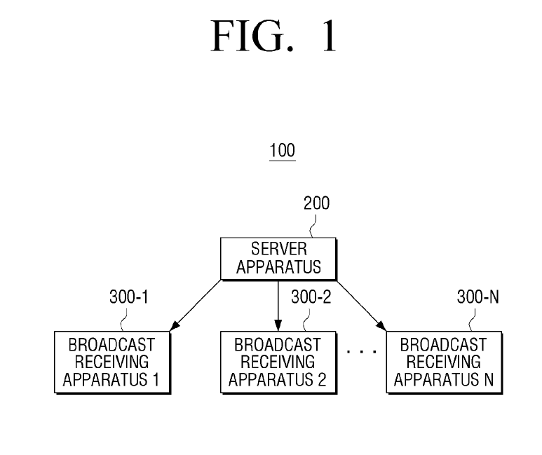

FIG. 1 is a diagram of a content recognition system 100 according to an embodiment. Referring to FIG. 1, the content recognition system 100 includes a server apparatus 200 and a plurality of broadcast receiving apparatuses 300-1, 300-2, . . . , 300-N.

The server apparatus 200 may communicate with the plural broadcast receiving apparatuses 300-1, 300-2, . . . , 300-N through a network, such as the Internet, a cable, a satellite, etc.

In response to content being received, the server apparatus 200 detects a plurality of fingerprints from at least one data among image data and voice data of the content and generates a fingerprint set selected from different fingerprints in consideration of a similarity between the plural detected fingerprints. That is, the server apparatus 200 does not periodically detect content to generate the fingerprint set but selects one fingerprint among similar fingerprints to generate the fingerprint set. Accordingly, the fingerprint set may include different fingerprints.

The server apparatus 200 stores the fingerprint set and transmits the fingerprint to the plural broadcast receiving apparatuses 300-1, 300-2, . . . , 300-N. In this case, since the fingerprint set includes different fingerprints with respect to one piece of content, the fingerprint set occupies low memory capacity.

In response to the fingerprint set being received from the server apparatus 200, the plural broadcast receiving apparatuses 300-1, 300-2, . . . , 300-N store the fingerprint set. In addition, in response to content being reproduced, the server apparatus 200 recognizes content viewed by a user using the fingerprint set. Related operations of the plural broadcast receiving apparatuses 300-1, 300-2, . . . , 300-N are the same and thus will be described with regard to the broadcast receiving apparatus 1 300-1.

In response to predetermined content being reproduced, the broadcast receiving apparatus 1 300-1 detects a plurality of target fingerprints from at least one piece of data among image data and voice data of the content. Here, the target fingerprint may be obtained by sampling any one of the image data and voice data of the content being reproduced and may be target data to be compared with a plurality of fingerprints contained in the fingerprint set.

In response to the plural target fingerprints being detected, the broadcast receiving apparatus 1 300-1 compares the plural target fingerprints with the plural fingerprints included in the fingerprint set. For example, when a first target fingerprint is compared with each of the plural fingerprints, if the first target fingerprint is matched to or matches at least one fingerprint, content recognition information may be generated. That is, when at least one of the plural target fingerprints detected from the content being reproduced is matched to at least one fingerprint, the broadcast receiving apparatus 1 300-1 may recognize that content corresponding to the matched fingerprint is currently viewed by a user.

The broadcast receiving apparatus 1 300-1 transmits the content recognition information to the server apparatus 200. Here, the content recognition information may indicate that content corresponding to a predetermined fingerprint is viewed by a user and include content identification information corresponding to the fingerprint matched to the target fingerprint and information about an apparatus for generating the content recognition information.

The server apparatus 200 may recognize the content that is currently viewed by the user of the broadcast receiving apparatus 1 300-1 using the identification information and apparatus information contained in the content recognition information.

As described above, in the content recognition system 100 according to the present embodiment, since the server apparatus 200 generates the fingerprint set including different fingerprints, the fingerprint set may occupy low memory capacity.

When the fingerprint set occupies low capacity, the server apparatus 200 may reduced storage capacity of the fingerprint set and transmit the fingerprint set to the plural broadcast receiving apparatuses 300-1, 300-2, . . . , 300-N with high speed. In addition, network fees required to transmit the fingerprint set to the plural broadcast receiving apparatuses 300-1, 300-2, . . . , 300-N may be reduced.

Since the number of fingerprints contained in the fingerprint set is reduced compared with a conventional case, the plural broadcast receiving apparatuses 300-1, 300-2, . . . , 300-N may reduce a number of times of comparison between the fingerprints and target fingerprints. Accordingly, the use of a central processing unit (CPU) may be reduced due to the aforementioned matching.

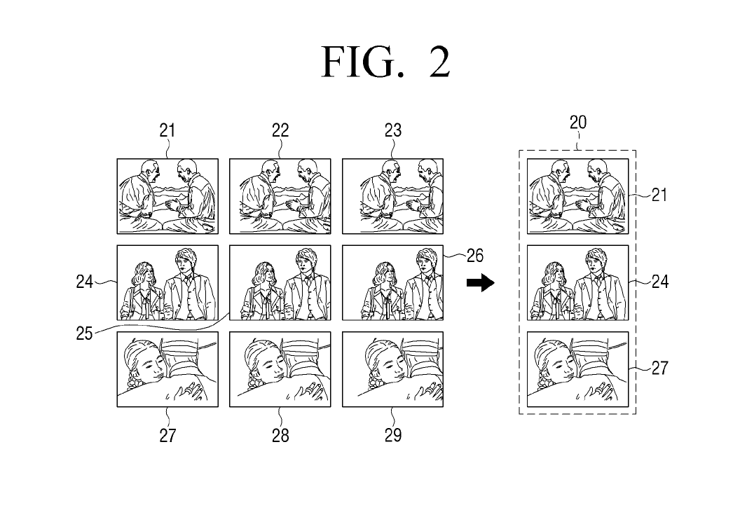

FIG. 2 is a diagram illustrating a method of generating a fingerprint set according to an embodiment.

Referring to FIG. 2, the server apparatus 200 samples image frames of advertisements in units of one to three seconds and detects or captures nine fingerprints 21, 22, 23, 24, 25, 26, 27, 28, and 29 of the advertisement content with replay time of about 15 seconds. The nine fingerprints 21 to 29 may be sequentially detected.

The server apparatus 200 determines the similarity between neighboring fingerprints among the nine fingerprints 21 to 29. In this case, when the neighboring fingerprints are image frames, the similarity between the fingerprints may be determined using a method of comparing at least one of an indication position, a size, a shape, and color of an object contained in each image frame. In addition, when neighboring fingerprints are audio signal periods, amplitude of audio signal periods and frequency characteristics may be compared to determine the similarity between the fingerprints.

In detail, the server apparatus 200 determines similarity between the first fingerprint 21 and the second fingerprint 22 and determines similarity between the second fingerprint 22 and the third fingerprint 23. In addition, the server apparatus 200 determines similarity between the third fingerprint 23 and the fourth fingerprint 24. In this case, the first to third fingerprints 21, 22, and 23 have high similarity according to an indication position, a size, a shape, and color of an object and the third fingerprint 23 and the fourth fingerprint 24 have low similarity, and thus, the server apparatus 200 may select one of the first to third fingerprints 21, 22, and 23.

In this manner, any one of fourth to sixth fingerprints 24, 25, and 26 having high similarity may be selected and any one of seventh to ninth fingerprints 27, 28, and 29 may be selected.

In addition, the server apparatus 200 may select the first fingerprint 21, the fourth fingerprint 24, and the seventh fingerprint 27 to generate one fingerprint set 20.

Although FIG. 2 illustrates the case in which all the nine fingerprints 21, 22, 23, 24, 25, 26, 27, 28, and 29 from advertisement content and then compares similarity between fingerprints, the embodiment is not limited thereto. As another method, the similarity between the fingerprints may be compared while detecting fingerprint from the advertisement content.

For example, when the first fingerprint 21 is detected from advertisement content and then the second fingerprint 22 is detected, the server apparatus 200 compares similarity between the first fingerprint 21 and the second fingerprint 22. In this case, since similarity between the first fingerprint 21 and the second fingerprint 22 is high, one of the first fingerprint 21 and the second fingerprint 22 is deleted.

When the second fingerprint 22 is deleted and then the third fingerprint 23 is detected, the server apparatus 200 compares similarity between the first fingerprint 21 and the third fingerprint 23. In this case, the similarity between the first fingerprint 21 and the third fingerprint 23 is high, one of the first fingerprint 21 and the third fingerprint 23 is deleted.

When the third fingerprint 23 is deleted and then the fourth fingerprint 24 is detected, the server apparatus 200 compares similarity between the first fingerprint 21 and the fourth fingerprint 24. In this case, since similarity between the first fingerprint 21 and the fourth fingerprint 24 is low, the first fingerprint 21 and the fourth fingerprint 24 are determined to be different fingerprints. Accordingly, the server apparatus 200 may first add the first fingerprint 21 to a fingerprint set 20. In addition, in response to the fifth fingerprint 25 being detected, the server apparatus 200 compares the fourth fingerprint 24 and the fifth fingerprint 25.

The server apparatus 200 may also apply the aforementioned method to the sixth to ninth fingerprints 26 to 29 in the same way and may add the fourth fingerprint 24 and the seventh fingerprint 27 to the fingerprint set 20.

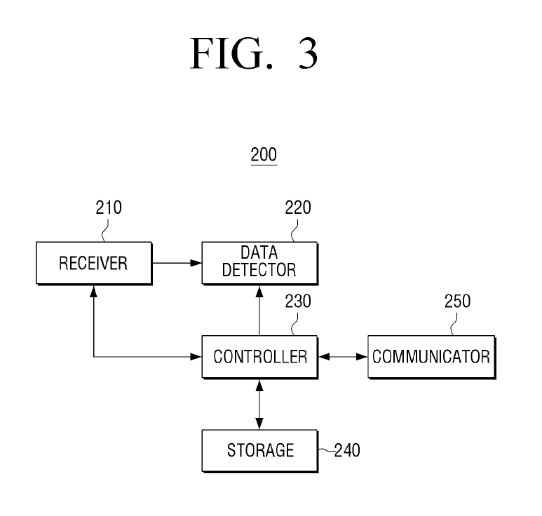

FIG. 3 is a diagram illustrating a structure of a server apparatus 200 according to an embodiment. Referring to FIG. 3, the server apparatus 200 includes a receiver 210, a data detector 220, a controller 230, a storage 240, and a communicator 250.

The receiver 210 receives content from a content provider. The content may be image data or voice data and may include both the image data and the voice data. The content provider may be a public TV broadcaster, a cable broadcaster, an IPTV broadcaster, a VOD system, etc. However, embodiments are not limited thereto. The content provider may further include a server, a system, or the like for providing content including image data or voice data.

In response to content being received by the receiver 210, the data detector 220 detects a plurality of fingerprints from at least one piece of data of image data and voice data of the content. The fingerprint may be feature data indicating features of various pieces of data, such as image data, voice data, or multimedia data formed by combining the image data and the voice data.

The data detector 220 may detect a plurality of fingerprints by sampling at least one of image data and voice data.

In detail, the data detector 220 may sample a plurality of video frames among video frames included in the image data with a predetermined first period to detect a plurality of fingerprints from the image data in that period.

In addition, the data detector 220 may sample a plurality of audio signal periods among audio signals included in the voice data with a predetermined second period to detect a plurality of fingerprints from the voice data in that period.

Here, the predetermined first and second periods may each be a time unit of 1 to 3 seconds. However, embodiments are not limited thereto. That is, the predetermined first and second periods may each be a time unit less than 1 second (e.g., 0.5 second). In addition, a time unit for detection of a plurality of fingerprints may be changed by a manager of the server apparatus 200.

The controller 230 controls an overall operation of the server apparatus 200.

First, in response to a plurality of fingerprints of one piece of content being detected by the data detector 220, the controller 230 may generate a fingerprint set selected as different fingerprints in consideration of similarity between plural fingerprints.

In detail, in response to a plurality of image frames being sampled by the data detector 220, the controller 230 may calculate a similarity between neighboring image frames based on at least one of an indication position, a size, a shape, and color of an object contained in each image frame.

The controller 230 may select an image frame one by one among image frames having a similarity within a predetermined first range. For example, when five image frame groups having the similarity within the first range are detected with respect to one piece of content and each image frame group includes three image frames, the controller 230 may select an image frame one by one from the five image frame groups. In addition, the controller 230 may generate a fingerprint set of corresponding content using five image content selected from the five image frame groups.

When a plurality of audio signal periods is sampled by the data detector 220, the controller 230 may calculate a similarity between neighboring audio signal periods based on the amplitude and frequency feature of an audio signal contained in each audio signal period.

The controller 230 may select an audio signal period one by one among audio signal periods having similarity within a predetermined second range. For example, when four audio signal groups having the similarity within the second range are detected with respect to one piece of content and each audio signal group includes three audio signal periods, the controller 230 may generate a fingerprint set of corresponding content using four audio signal periods selected from the four audio signal groups.

When the controller 230 generates the fingerprint set, the fingerprint set may add or include content identification information for identifying content associated with the fingerprint set to the fingerprint set.

When the fingerprint set is generated, the controller 230 stores the fingerprint set in the storage 240. The storage 240 stores a set list including at least one fingerprint set. When a new fingerprint set is generated, the controller 230 may add the new fingerprint set to the set list stored in the storage 240 to update the set list. When the set list is updated, a version of the set list and an update date of the set list may be changed and recorded in the set list. Thus far, although the case in which the set list is updated when the fingerprint set is added to the set list has been described, embodiments are not limited thereto. That is, even if any one of at least one of the fingerprint sets included in the set list is deleted, the set list may be updated.

The controller 230 may transmit version information about the updated set list to a broadcast receiving apparatus through the communicator 250. In addition, in response to an update request being received from a broadcast receiving apparatus, the controller 230 may transmit the updated set list or the newly generated fingerprint set to the broadcast receiving apparatus through the communicator 250.

In addition, when a version of a set list that is pre-provided to a broadcast receiving apparatus is different from a version of the set list stored in the storage 240, the controller 230 may transmit the updated set list or the newly generated fingerprint set to the broadcast receiving apparatus through the communicator 250.

When predetermined event information about content is present, the controller 230 may match the event information to the fingerprint set and transmit the event information to the broadcast receiving apparatus. Here, the predetermined event information may be associated with the content. For example, when the content is a cola soft drink advertisement, the predetermined event information may be a cola giveaway event information, cola survey event information, cola website access information, cola detailed information, etc.

The predetermined event information may be provided from a content provider. When the content provider makes a contract with a content producer to provide an event of a specific content, event information provided from the content provider may be transmitted to the server apparatus 200. Here, the content producer may be a content company. For example, when content is a cola advertisement, the content producer may be the company cola or a producer for producing cola advertisement.

When comparison activation information containing comparison initiation time and comparison completion time of the fingerprint set is present, the controller 230 may transmit the comparison activation information to the broadcast receiving apparatus. Here, the comparison initiation time and the comparison completion time refer to points of time for initiating and terminating an operation of detecting a plurality of target fingerprints from the content being reproduced and comparing a plurality of target fingerprints with a plurality of fingerprints containing a fingerprint set.

In addition, the comparison activation information may also be provided from the content provider. That is, when the content provider makes a contract with a content producer to provide specific content, the comparison activation information may be generated using time when the specific content is broadcast. For example, when the content is a cola advertisement, the content provider may know when the cola advertisement is broadcast. Thus, when the fingerprint set is the cola advertisement, the content provider may set information about the time when the cola advertisement is broadcast using the comparison initiation time and comparison completion time and generate the comparison activation information. In this case, the comparison activation information may further include content identification information.

The controller 230 may transmit the comparison activation information to the broadcast receiving apparatus separately from the fingerprint set or may match the comparison activation information to the fingerprint set and transmit the comparison activation information to the broadcast receiving apparatus.

By transmitting the fingerprint set to the broadcast receiving apparatus, the controller 230 may control the broadcast receiving apparatus to check whether content corresponding to the fingerprint set is reproduced by the broadcast receiving apparatus. When the content corresponding to the fingerprint set is reproduced by the broadcast receiving apparatus, this means that a user is viewing the content. Thus, the broadcast receiving apparatus may recognize the content viewed by the user using the fingerprint set or may generate the content recognition information and transmit the content recognition information to the server apparatus 200.

Accordingly, in response to the content recognition information being received from a plurality of broadcast receiving apparatuses, the controller 230 may collect the content recognition information and analyze ratings of content. Since the content recognition information contains apparatus information, the controller 230 may analyze advertisement exposure, preferred content, etc. according to a type of the apparatus (e.g., a model name and a manufacturer) based on the apparatus information.

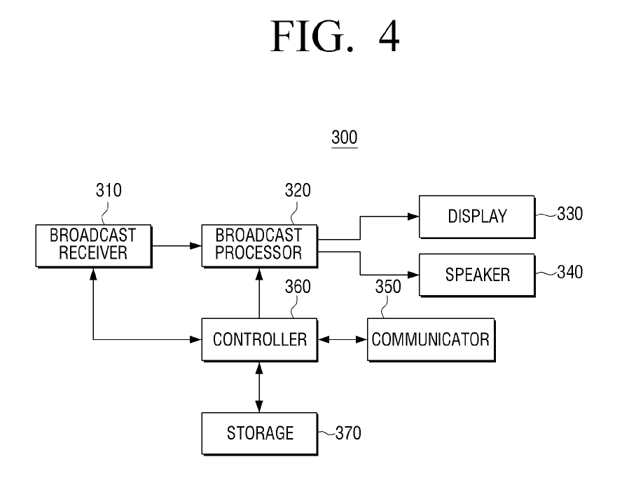

FIG. 4 is a diagram illustrating a structure of a broadcast receiving apparatus 300 according to an embodiment. Referring to FIG. 4, the broadcast receiving apparatus 300 includes a broadcast receiver 310, a broadcast processor 320, a display 330, a speaker 340, a communicator 350, a controller 360, and a storage 370. The same structure as the structure of the broadcast receiving apparatus 300 may also be applied to each of the plural broadcast receiving apparatuses 300-1, 300-2, . . . , 300-N illustrated in FIG. 1.

The broadcast receiver 310 receives broadcast content through various sources, such as a public TV broadcaster, a cable broadcaster, an IPTV broadcaster, a VOD system, etc.

The broadcast processor 320 may image-decode or voice-decode at least one of image data and voice data of the broadcast content or perform signal-processing, such as image scaling.

The display 330 displays the image data signal-processed by the broadcast processor 320 on a screen. In addition, the speaker 340 outputs the voice data signal-processed by the broadcast processor 320.

The communicator 350 communicates with a server apparatus through a network, such as the Internet, a cable, a satellite, etc. Here, the server apparatus may be a server that checks whether predetermined contents are viewed by a user of the broadcast receiving apparatus 300 and analyze ratings of the predetermined contents or provides a user target service.

The controller 360 controls an overall operation of the broadcast receiving apparatus 300. Here, the controller 360 may be a central processing unit (CPU).

In detail, in response to a fingerprint set or undated set list being received from the server apparatus, the controller 360 stores the fingerprint set or the updated set list in the storage 370.

The storage 370 stores the set list received from the server apparatus. In response to the fingerprint set being received from the server apparatus, the controller 360 adds the fingerprint to the set list.

In addition, in response to the updated set list being received from the server apparatus, the controller 360 deletes a pre-stored set list and stores an updated set list in the storage 370. The set list records a version of the set list and an update date of the set list.

Prior to reception of the fingerprint set from the server apparatus, the communicator 350 may receive version information of the set list from the server apparatus. In this case, when the set list received from the server apparatus is different from the version of the set list pre-stored in the storage 370, the controller 360 may transmit an update request of the set list to the server apparatus. According to the update request, the communicator 350 may receive a recent version of set list or a new fingerprint set from the server apparatus.

The controller 360 may periodically sample at least one of image data and voice data of broadcast content reproduced by the broadcast receiving apparatus 300 to detect or capture a plurality of target fingerprints.

In addition, the plural target fingerprints and a plurality of fingerprints contained in the fingerprint set are compared.

For example, when a first target fingerprint is compared with each of the plural fingerprints, if the first target fingerprint is matched to at least one fingerprint, the controller 360 may recognize that content corresponding to the matched fingerprint is currently being viewed by the user.

The fingerprint or the fingerprint set may include predetermined event information. Thus, when the fingerprint (or a fingerprint set containing the fingerprint) matched to any one of target fingerprints contains event information, the controller 360 may control the display 330 to display event information.

That is, since the controller 360 compares a plurality of target fingerprints and a plurality of fingerprints contained in the fingerprint set while sampling the plural target fingerprints from content being reproduced, when any one of the target fingerprints are matched to a fingerprint including event information, the event information may be immediately displayed during reproduction of the content. Accordingly, while a user views the content, the user may view event information associated with the content together.

In response to comparison activation information containing comparison initiation time and comparison completion time for the fingerprint set from the server apparatus, the controller 360 may initiate and terminate an operation of detecting a plurality of target fingerprints according to the comparison activation information and comparing the plural target fingerprints and the fingerprint set.

For example, when the comparison initiation time is reached during reproduction of broadcast content, the controller 360 detects a plurality of target fingerprints to be compared with a fingerprint set from the comparison initiation time and compares the plural target fingerprints with a plurality of fingerprints contained in the fingerprint set. In addition, when the comparison completion time is reached, the operation of detecting the target fingerprint and comparing the target fingerprint with a plurality of fingerprints is terminated.

When the detection operation of the target fingerprint and the comparison operation are initiated and terminated according to the comparison activation information, the aforementioned detection operation and comparison operation do not have to be performed on all broadcast contents being reproduced. That is, the aforementioned detection operation and comparison operation may be performed only for a period of time when broadcast content to be recognized is reproduced. Thus, use of the controller 360 due to aforementioned detection operation and comparison operation may be reduced.

According to the aforementioned detection operation and comparison operation, when the controller 360 recognizes that a user currently views content corresponding to the fingerprint set, the controller 360 may generate content recognition information.

Here, the content recognition information may include content identification information corresponding to a fingerprint (or a fingerprint set containing the fingerprint) matched to a target fingerprint and information of an apparatus for generating the content recognition information. For example, when the content corresponding to the fingerprint is a cola advertisement, the content identification information may be “cola ver.135”. In addition, when the broadcast receiving apparatus is a TV, the apparatus information may be a TV manufacturer and a model name “Samsung_UN40FXXXXX”.

The controller 360 transmits the content recognition information to the server apparatus, and the server apparatus may analyze information associated with the content.

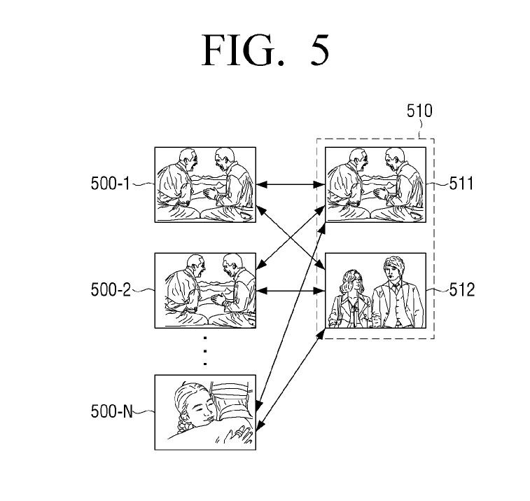

FIG. 5 is a diagram illustrating a fingerprint matching method according to an embodiment. The fingerprint matching method of FIG. 5 may be performed by the broadcast receiving apparatus.

Referring to FIG. 5, the broadcast receiving apparatus detects a plurality of target fingerprints 500-1, 500-2, . . . , 500-N from content being currently reproduced.

The broadcast receiving apparatus compares the plural target fingerprints 500-1, 500-2, . . . , 500-N with first and second fingerprints 511 and 512 contained in the fingerprint set 510.

In detail, the first target fingerprint 500-1 is compared with each of the first and second fingerprints 511 and 512 and the second target fingerprint 500-2 is compared with each of the first and second fingerprints 511 and 512. In this manner, up to N^{th} target fingerprint 500-N is compared with each of the first and second fingerprints 511 and 512.

When each of the first and second target fingerprints 500-1 and 500-2 is matched to the first fingerprint 511, the broadcast receiving apparatus may recognize that content corresponding to the fingerprint set 510 is currently being viewed by a user.

The broadcast receiving apparatus may generate content recognition information. In this case, the broadcast receiving apparatus may detect content identification information contained in the fingerprint set 510 and detect apparatus information of the broadcast receiving apparatus to generate the content recognition information.

In addition, the broadcast receiving apparatus may transmit the content recognition information to a server apparatus. Thus, the server apparatus may check content viewed by the user of the broadcast receiving apparatus using the content recognition information.

The fingerprint set 510 is received from the server apparatus and is stored in the broadcast receiving apparatus. Although FIG. 5 illustrates one fingerprint set 510, a plurality of fingerprint sets may be stored in the broadcast receiving apparatus. When the plural fingerprint sets are stored, the broadcast receiving apparatus may compare the plural target fingerprints 500-1, 500-2, . . . , 500-N and plurality of fingerprint sets, respectively.

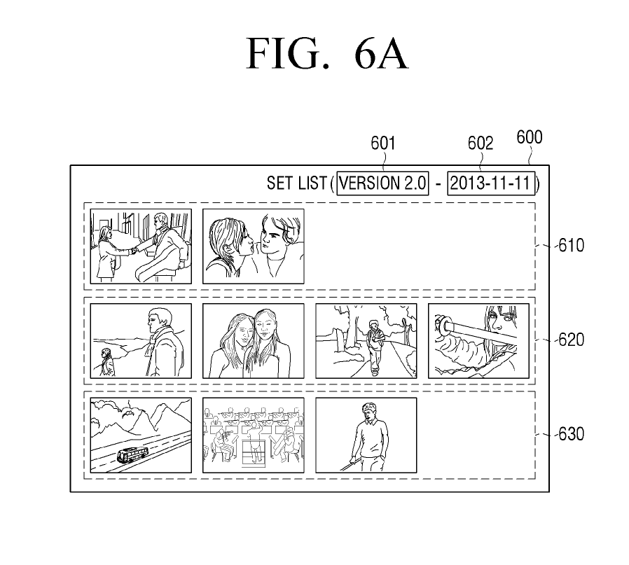

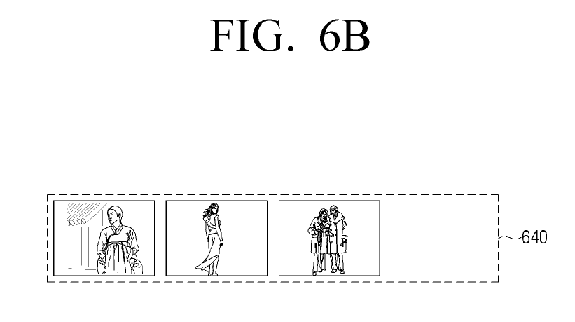

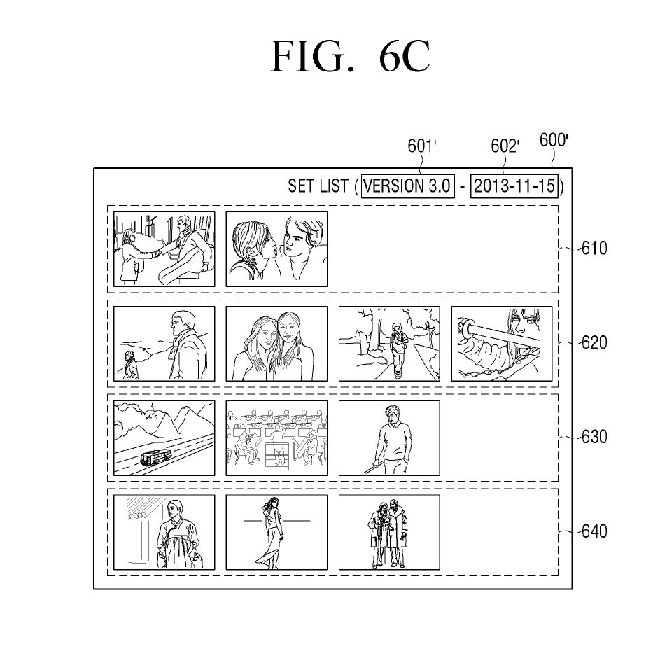

FIGS. 6A and 6B are diagrams illustrating a method of updating a fingerprint according to an embodiment. Referring to FIG. 6A, a server apparatus stores a set list 600. A version 601 of the set list 600 and an update date 602 of the set list 600 are recorded in an upper end of the set list 600. That is, it may be seen from that the set list 600 is version 2.0 and was updated on Nov. 11, 2013.

The set list 600 includes first to third fingerprint sets 610, 620, and 630. The first to third fingerprint sets 610, 620, and 630 are associated with different contents and each include a plurality of fingerprints.

As illustrated in FIG. 6B, the server apparatus may detect three fingerprints from content to newly generate a fourth fingerprint set 640. When the new fingerprint set 640 is generated, the server apparatus adds the fourth fingerprint set 640 to the set list 600 illustrated in FIG. 6A. Accordingly, as illustrated in FIG. 6C, an updated set list 600′ is stored. As the fourth fingerprint set 640 is added, the updated set list 600′ includes first to fourth fingerprint sets 610, 620, 630, and 640.

A version 601′ of the set list 600′ and an update date 602′ of the set list 600′ are recorded in an upper end of the updated set list 600′. That is, it may be seen that the updated set list 600′ is version 3.0 and was updated on Nov. 15, 2013.

Although FIGS. 6A to 6C illustrate the updating method of adding a fingerprint set to the set list 600, embodiments of the present invention are not limited thereto. For example, when a third fingerprint set 630 is deleted from the set list 600, the set list 600 may also be updated.

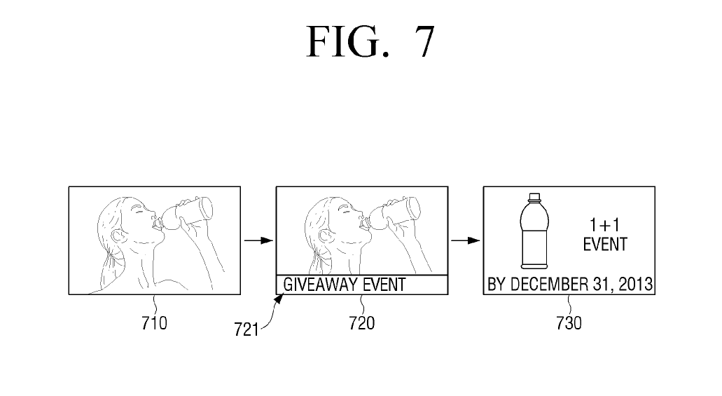

FIG. 7 is a diagram illustrating a method of displaying event information according to an embodiment.

While content 710 is being reproduced, a broadcast receiving apparatus compares a plurality of target fingerprints with a plurality of fingerprints contained in a fingerprint set while detecting the plural target fingerprints from the content 710.

When any one of the target fingerprints is matched to a fingerprint containing event information, the broadcast receiving apparatus displays event information 721 in a banner form on a screen 720 on which content is currently being reproduced. Thus, the user may recognize that there is the event information 721 associated with content being currently reproduced.

When the user wants to view the event information 721 in detail, the user may select the event information 721 using a remote controller, or the like.

In response to the event information 721 being selected, the broadcast receiving apparatus may display an event image 730 corresponding to the event information 721. Thus, while the user views content, the user may check event information associated with the content.

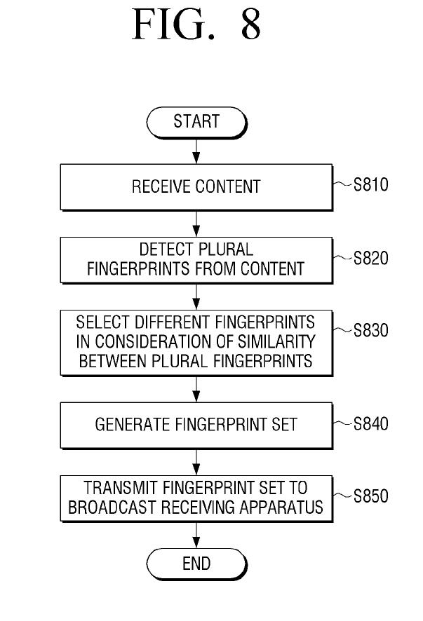

FIG. 8 is a flowchart for transmitting a fingerprint according to an embodiment. The fingerprint transmitting method of FIG. 8 may be performed by a server apparatus.

In response to content being received from a content provider (S810), the server apparatus detects a plurality of fingerprints from the content (S820). In detail, the plural fingerprints may be detected from at least one of image data and voice data of the content. In addition, the server may detect a plurality of fingerprints only from content determined by a content provider.

The server apparatus selects different fingerprints in consideration of similarity between plural fingerprints (S830) and generates a fingerprint set including the selected fingerprints (S840). Here, the plural fingerprints are image frames, the similarity between the plural fingerprints may be determined by comparing indication positions, sizes, shapes, and colors of objects contained in respective image frames. In addition, when a plurality of fingerprints is audio signal periods, the similarity between the plural fingerprints may be determined by comparing amplitudes of each audio signal period and frequency characteristics. In addition, one of a plurality of fingerprints with predetermined similarity may be selected to generate a fingerprint set.

The server apparatus transmits the fingerprint set to the broadcast receiving apparatus (S850). The fingerprint set may be transmitted to the broadcast receiving apparatus so as to control the broadcast receiving apparatus to check whether content corresponding to the fingerprint set is currently reproduced. Accordingly, the server apparatus may receive content recognition information from the broadcast receiving apparatus and analyze advertisement exposure, preferred content, etc. using the content recognition information.

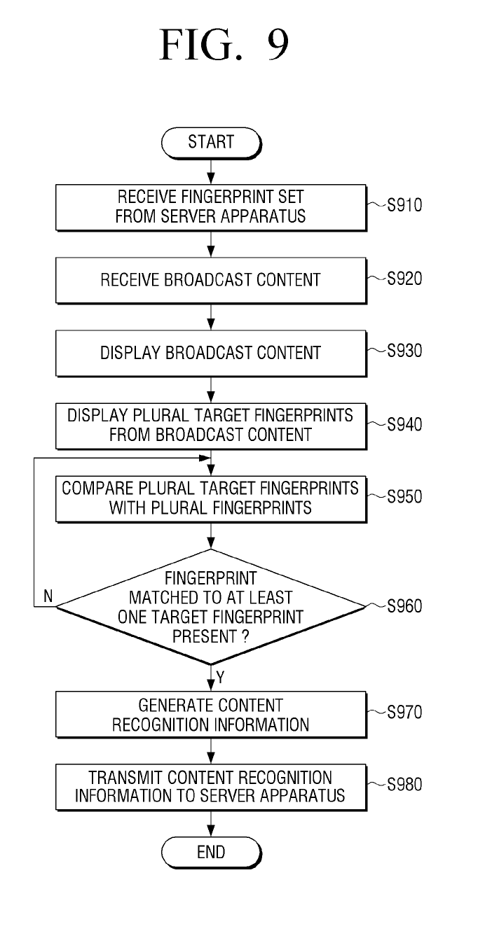

FIG. 9 is a flowchart for explanation of a method of recognizing content according to an embodiment. The content recognition method illustrated in FIG. 9 may be performed by a broadcast receiving apparatus.

The broadcast receiving apparatus receives a fingerprint set from a server apparatus (S910). The fingerprint set includes a plurality of fingerprints of predetermined content.

In response to broadcast content being received (S920), the broadcast receiving apparatus displays the broadcast content (S930). In response to the broadcast content being displayed, the broadcast receiving apparatus detects a plurality of target fingerprints from the broadcast content (S940) and compares the plural target fingerprints with a plurality of fingerprints contained in the fingerprint set (S950).

Via the aforementioned comparison (S950), when a fingerprint matched to at least one target fingerprint is present (S960), the broadcast receiving apparatus generates content recognition information about the fingerprint (S970). The content recognition information is information indicating that content corresponding to the fingerprint is currently being viewed by a user and includes content identification information about the fingerprint and apparatus information of the broadcast receiving apparatus.

The broadcast receiving apparatus transmits the content recognition information to the server apparatus (S980).

Although FIG. 9 illustrates the case operations S940 and S950 are performed during display of broadcast content, embodiments are not limited thereto. In detail, in response to comparison activation information associated with operations S940 and S950 being received from the server apparatus, the broadcast receiving apparatus may perform operations S940 and S950 only on broadcast content displayed to comparison completion time from comparison initiation time contained in comparison activation information.

The fingerprint transmitting and content recognition method according to the aforementioned various embodiments may be coded in the form of software executed by a computer. The software may be recorded in a non-transitory computer readable medium and used in an apparatus such as a display apparatus, a glass apparatus, etc.

A non-transitory computer readable medium for recording thereon a program for executing the aforementioned gesture input processing method according to the embodiments may be provided. Here, the non-transitory computer readable medium is a medium that semi-permanently stores data and from which data is readable by a device, but not a medium that stores data for a short time, such as register, a cache, a memory, and the like. In detail, examples of the non-transitory computer readable medium may include a compact disc (CD), a digital versatile disc (DVD), a hard disc, a bluray disc, a universal serial bus (USB), a memory card, a read only memory (ROM), and the like.

The foregoing exemplary embodiments and advantages are merely exemplary and are not to be construed as limiting the embodiments. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. A server apparatus, comprising:
a receiver configured to receive content;
a data detector configured to detect a plurality of fingerprints from at least one of image data and voice data of the content;
a controller configured to generate a fingerprint set selected as different fingerprints in consideration of a similarity between the plurality of fingerprints as a generated fingerprint set; and
a communicator configured to transmit the generated fingerprint set to a broadcast receiving apparatus.

2. The server apparatus as claimed in claim 1, further comprising:
a storage configured to store a set list comprising at least one fingerprint set,
wherein the controller adds the generated fingerprint set to the set list to update the set list as an updated set list.

3. The server apparatus as claimed in claim 2, wherein the controller transmits version information of the updated set list to the broadcast receiving apparatus through the communicator, and transmits one of the updated set list and the generated fingerprint set to the broadcast receiving apparatus in response to an update request being received from the broadcast receiving apparatus.

4. The server apparatus as claimed in claim 2, wherein, when one version of a set list pre-provided to the broadcast receiving apparatus is different from another version of the set list, the controller transmits the one of the updated set list and the generated fingerprint set to the broadcast receiving apparatus.

5. The server apparatus as claimed in claim 1, wherein, when predetermined event information about the content is present, the controller matches the event information to the fingerprint set and transmits the event information to the broadcast receiving apparatus.

6. The server apparatus as claimed in claim 1, wherein, when comparison activation information comprising comparison initiation time and comparison completion time of the fingerprint set is present, the controller transmits the comparison activation information to the broadcast receiving apparatus.

7. The server apparatus as claimed in claim 1, wherein the data detector detects the plurality of fingerprints as plural image frames by one of sampling a plurality of image frames among image frames included in the image data with a predetermined first period and sampling a plurality of audio signal periods among audio signals included in the voice data with a predetermined second period as plural audio signal periods.

8. The server apparatus as claimed in claim 7, wherein:
in response to the plural image frames being sampled, the controller calculates a first similarity between neighboring image frames based on at least one of an indication position, a size, a shape, and a color of an object included in each of the plural image frames, and generates the fingerprint set by selecting an image frame one by one among image frames having the first similarity within a predetermined first range; and
in response to the plural audio signal periods being sampled, the controller calculates a second similarity between neighboring audio signal periods based on a frequency characteristic and amplitude of an audio signal contained in each of the plural audio signal periods, and generates the fingerprint set by selecting an audio signal period one by one among audio signal periods having the second similarity within a predetermined second range.

9. A method of transmitting a fingerprint list of a server apparatus, the method comprising:
in response to content being received, detecting a plurality of fingerprints from at least one of image data and voice data of the content;
generating a fingerprint set selected as different fingerprints in consideration of a similarity between the plurality of fingerprints as a generated fingerprint set; and
transmitting the generated fingerprint set to a broadcast receiving apparatus.

10. The method as claimed in claim 9, further comprising:
adding the generated fingerprint set to a set list comprising at least one fingerprint set to update the set list as an updated set list.

11. The method as claimed in claim 10, wherein the transmitting comprises:
transmitting version information of the updated set list to the broadcast receiving apparatus; and
transmitting one of the updated set list and the generated fingerprint set to the broadcast receiving apparatus in response to an update request being received from the broadcast receiving apparatus.

12. The method as claimed in claim 10, wherein the transmitting comprises:
when one version of a set list pre-provided to the broadcast receiving apparatus is different from another version of the set list, transmitting one of the updated set list and the generated fingerprint set to the broadcast receiving apparatus.

13. The method as claimed in claim 9, wherein the transmitting comprises:
when predetermined event information about the content is present, matching the event information to the fingerprint set and transmitting the event information to the broadcast receiving apparatus.

14. The method as claimed in claim 9, further comprising:
when comparison activation information containing comparison initiation time and comparison completion time of the fingerprint set is present, transmitting the comparison activation information to the broadcast receiving apparatus.

15. The method as claimed in claim 9, wherein the detecting comprises one of sampling a plurality of image frames among image frames as plural image frames included in the image data with a predetermined first period and sampling a plurality of audio signal periods as plural audio signals among audio signals included in the voice data with a predetermined second period to detect the plural fingerprints.

16. The method as claimed in claim 15, wherein the generating comprises:
in response to the plural image frames being sampled, calculating a first similarity between neighboring image frames based on at least one of an indication position, a size, a shape, and a color of an object included in each of the plural image frames, and generate the fingerprint set by selecting an image frame one by one among image frames having the first similarity within a predetermined first range; and
in response to the plural audio signal periods being sampled, calculating a second similarity between neighboring audio signal periods based on a frequency characteristic and amplitude of an audio signal contained in each of the plural audio signal periods, and generate the fingerprint set by selecting an audio signal period one by one among audio signal periods having the second similarity within a predetermined second range.

17. A broadcast receiving apparatus for recognizing content viewed by a user, the broadcast receiving apparatus comprising:
a receiver configured to receive broadcast content;
a display configured to display the broadcast content;
a communicator configured to communicate with a server apparatus and to receive a fingerprint set comprising a plurality of fingerprints of content as a recognition target from the server apparatus; and
a controller configured to detect the plurality of fingerprints from at least one of image data and voice data of the broadcast content, to compare plural target fingerprints with the plurality of fingerprints, to generate content recognition information of a fingerprint matched to at least one of the plural target fingerprints, and to transmit the content recognition information to the server apparatus through the communicator,
wherein the fingerprint set comprises a plurality of fingerprints selected as different fingerprints in consideration of a similarity between the plurality of fingerprints detected from at least one of image data and voice data of the content.

18. The broadcast receiving apparatus as claimed in claim 17, wherein the content recognition information comprises content identification information corresponding to a fingerprint matched to at least one of plural target fingerprints and apparatus information of the broadcast receiving apparatus.

19. The broadcast receiving apparatus as claimed in claim 17, wherein, when predetermined event information of the content is matched to the fingerprint set, if at least one of plural target fingerprints is matched to at least one fingerprint included in the fingerprint set, the controller controls the display to display the predetermined event information.

20. The broadcast receiving apparatus as claimed in claim 17, wherein, in response to comparison activation information comprising comparison initiation time and comparison completion time of the fingerprint set being from the server apparatus, the controller activates an operation of detecting the plural target fingerprints and comparing the plural target fingerprints with the plurality of fingerprints according to the comparison initiation time, and deactivates an operation of detecting the plural target fingerprints and comparing the target fingerprints with the plurality of fingerprints according to the comparison completion time.

21. A method, comprising:
comparing a media fingerprint of broadcast media content with stored fingerprints of media content; and
displaying event information corresponding to a matching one of the stored fingerprints,
wherein the stored fingerprints of media content are representative of different media content that may be broadcast.
